(19) United States
(12) Patent Application Publication
(10) Pub. No.: US 2014/0339820 A1
(43) Pub. Date: Nov. 20, 2014

(54) PLUG-IN CONNECTION WITH RETAINING ELEMENT AND RETAINING ELEMENT FOR THIS PURPOSE

(71) Applicant: Caterpillar Global Mining Europe GmbH, Lunen, (DE)

(72) Inventors: Franz-Heinrich Suilmann, Werne (DE); Leonie Bernemann, Lunen (DE); Bjorn Scherweit, Ludinghausen (DE)

(73) Assignee: Caterpillar Global Mining Europe GmbH, Lunen (DE)

(21) Appl. No.: 14/362,025

(22) PCT Filed: Nov. 30, 2012
(86) PCT No.: PCT/EP2012/004956

§ 371 Date: May 30, 2014

(30) Foreign Application Priority Data
Dec. 13, 2011 (DE) 202011052283.0

(51) Int. Cl. F16L 37/14

(52) U.S. Cl. CPC F16L 37/144
USPC 285/319

(57) ABSTRACT

A plug-in connection for hydraulic hose lines includes a first plug connector having a circumferential groove on a plug-in nipple, a plug-in sleeve having two transverse bores, and a fork-shaped coupling bracket. The coupling bracket has two bracket portions and one bracket curve, which may be being inserted into the transverse bores for locking the plug-in connection to the bracket portions and penetrate the groove transversely with respect to the plug-in axis. A retaining element for retaining the coupling bracket is also provided and includes an accommodating portion for the bracket curve, two holding arms which are spaced apart from each other and connected by a base at rear ends of the holding arms facing the accommodating portion, and which define at front ends a mounting mouth which can be slipped onto the plug-in nipple and/or the plug-in sleeve in a transverse manner with respect to the plug-in axis.

### TECHNICAL FIELD

The present disclosure relates to a plug-in connection, in particular for hydraulic hose lines, preferably for use in hydraulic mining, mine working support and in the case of dust suppression. A plug-in connection of this type may have a first plug connector part as the male part which has a circumferential groove on a plug-in nipple, and a plug-in sleeve as the second plug connector part or female part which can be fitted together with the plug-in nipple and which may have two transverse bores. A fork-shaped coupling bracket may have two bracket portions and one bracket curve and which, in the mounted state of the plug-in sleeve and the plug-in nipple, may be inserted into the transverse bores for locking the plug-in connection to the bracket portions and may penetrates the groove transversely with respect to the plug-in axis. A retaining element for retaining the coupling bracket against unwanted release may have an accommodating portion for the bracket curve.

The present disclosure also relates to a retaining element for retaining a coupling bracket with a bracket curve and bracket portions against unwanted release on a plug-in connection with a plug-in nipple and plug-in sleeve which can be fitted together. The retaining element may be provided with an accommodating portion on the retaining element for the bracket curve of the coupling bracket.

### BACKGROUND

Plug-in connections for hydraulic hose lines, in particular for use in mining have been known for a long time and, among other things, DIN standard 20043 exists in Germany for plug-in connections of hydraulic hose lines for hydraulic mine working support and operating means for dust suppression. The corresponding standard establishes, in part in dependence on the nominal diameter DN of the hose, the fundamental design of the plug-in nipple and the plug-in sleeve as well as the coupling bracket including certain boundary dimensions for the individual components.

When mounting the coupling bracket in the case of a plug-in connection which has already been fitted together, in operating practice e.g. by mounting the coupling bracket by means of a hammer, the coupling bracket can experience deformation which promotes the coupling bracket creeping out in particular in the case of repeated load changes caused by disconnecting the hydraulic operating means or pressure fluctuations. As the operating practices hardly change in spite of all the training and explanation measures and, in addition, also caused by faulty mounting as a result of not inserting the coupling brackets far enough, there is a risk of a plug-in connection being able to be released during active operation, as a result of which serious damage brought about by error functions and/or environmental contamination can be caused, some mine operators demand the presence of an additional retaining means for retaining the plug-in connection.

A plug-in connection together with a retaining element is known from WO2008/055 288 Al. In the case of the known solution, the retaining element consists of a flexible band, in particular a plastics material band in the manner of a cable tie, which, compared to a cable tie however, is provided with an accommodating portion for the bracket curve of the coupling bracket and with two circular holes for the penetration of the ends of the bracket portions of the coupling bracket. Once the plug-in connection has been fitted together and the coupling bracket pushed in, the retaining element is placed around the part of the plug-in connection in which the coupling bracket is arranged. The toothed portion on the one strip end is then inserted into the closure head provided with the holding strap and shortened in order to prevent the coupling bracket creeping out of the groove in an unwanted manner in the mounted state.

The cable-tie-like retaining element does ensure a high degree of reliability in the mounted state, but the mounting procedure is difficult in particular where space is tight and/or vision is bad. The wearing of gloves also makes the mounting procedure substantially more difficult. To be released again, the retaining element has to be destroyed and replaced by a new retaining element of the identical type.

It might be an object of the present disclosure to create a retaining element which, in a reliable manner, prevents the coupling bracket from creeping out without having the aforementioned disadvantages.

### SUMMARY

According to the present disclosure a plug-in connection (10), in particular for hydraulic hose lines, may comprise a plug-in axis, a first plug connector part having a plug-in nipple, a circumferential groove being provided on the plug-in nipple, and a plug-in sleeve as a female part, the plug-in sleeve being fittable together with the plug-in nipple and having two transverse bores. A fork-shaped coupling bracket may include two bracket portions and one bracket curve, the fork-shaped coupling bracket being inserted, in the mounted state of the plug-in sleeve and the plug-in nipple, into the transverse bores for locking the plug-in connection to the bracket portions and penetrating the groove transversely with respect to the plug-in axis. A retaining element for retaining the coupling bracket against unwanted release may include an accommodating portion for the bracket curve and two holding arms. The two holding arms may be spaced apart from each other, may be connected by means of a base at rear ends of the holding arms facing the accommodating portion, and may define at front ends a mounting mouth which can be slipped onto the plug-in nipple and/or the plug-in sleeve in a transverse manner with respect to the plug-in axis of the plug-in connection.

According to the present disclosure a retaining element for retaining a coupling bracket having a bracket curve and bracket portions against unwanted release on a plug-in connection having a plug-in nipple and plug-in sleeve which can be fitted together, in particular on a plug-in connection as mentioned above, may comprise an accommodating portion for the bracket curve of the coupling bracket and two holding arms. The two holding arms may be being spaced apart from each other and may be connected by means of a base at rear ends located facing the accommodating portion. The two holding arms may define at front ends a mounting mouth being slippable onto the plug-in nipple or a plug-in sleeve of the plug-in connection in a transverse manner with respect to a plug-in axis of the plug-in connection.

The mounting mouth that can be slipped on could make it possible not only to still be able to attach the retaining element in a selective manner at the end of the mounting operation of the plug-in connection, but at the same time it may ensures that the retaining element can be released in a destruction-free manner and that once the plug-in connection has been fitted together again, the retaining element is able to be mounted again. Nonetheless, with the retaining element mounted, the coupling bracket is prevented from creeping out.

According to a particularly preferred exemplary embodiment, the mounting mouth may form a plug-in nipple gripping means with a self-holding function on the plug-in nipple. To this end, according to one exemplary embodiment, the holding arms may have inner surfaces which are located facing each other, the distance between the front ends of which is smaller than in a central portion of the holding arms or than in the widest area in the plug-in nipple gripping means. The tapering of the holding arms toward the front end in relation to the maximum inside diameter in the plug-in nipple gripping means of the mounting mouth ensures the self-holding function on the plug-in nipple in a particularly simple manner. The holding arms can have inner surfaces which extend in a curved manner in the shape of a crescent and extend in particular over the entire length or at all events over a decisive part region in a curved manner in the shape of a crescent. It is advantageous to the mounting procedure when the front ends have a rounded transition from their inner surfaces to their outer surfaces. In order to promote the widening, it is advantageous when a slot is realized in the base between the rear ends.

The holding arms can be connected together by means of the accommodating portion. In particular in the case of said development, the slot could extend in the base as far as up to the accommodating portion. It is particularly advantageous when the accommodating portion is provided with an inspection opening onto the bracket curve such that it is possible to carry out a visual check on the presence of the coupling bracket from all sides without any problem.

A retaining element can also be developed in such a manner that it is locked to the plug-in sleeve in addition or exclusively, to which end, according to a particularly advantageous exemplary embodiment, the front ends of the holding arms can be provided with holding lugs which protrude vertically downward, consequently axially in the direction of the accommodating portion for gripping behind the plug-in sleeve. In the case of the mounting of the retaining element, a certain mobility of the holding arms transversely with respect to the direction of displacement, consequently over its length, has then to be ensured. A slot in the base can be omitted, but could be present if a self-holding function is additionally provided on the plug-in nipple by a narrowing at the mounting mouth. Where locking lugs are present, the holding arms ought to allow for sufficient bending over their length so that when the retaining position is achieved, the lugs are able to grip behind an outer surface of the plug-in sleeve which is located facing away from the bracket curve.

The holding arms with the mounting mouth are preferably arranged axially offset with respect to the accommodating portion. According to an advantageous development, the base can form a transition step between the accommodating portion and the holding arms for the axial offset, wherein the holding arms extend on the one side and the accommodating portion extends on the other side of the transition step.

In the case of all the developments, the accommodating portion can be realized as a circular arc segment with a rear wall, a top surface and a bottom surface. The accommodating portion can then at the same time form a gripping portion. In the case of one exemplary embodiment, the top surface, for this purpose, can merge into the transition step, which extends perpendicularly with respect to the top surface, the bottom surface being realized at the same time as an edge collar, which grips only in a partial manner under a bracket curve which is arranged in the accommodating portion. Here too a certain flexibility of the retaining element is utilized in order to move the retaining element into a retaining position, in which, on the one hand, it is secured against release by means of the bracket lugs or the self-holding function and at the same time also finds a holding-back means on the opposite side, namely on the bracket curve of the coupling bracket.

According to another further alternative development, the holding arms can form a cylindrical part shell which can be slipped onto the circumference of the plug-in sleeve, onto the circumference of a hose end connected to the plug-in sleeve or onto a hose coupling at the end of the hose.

In the case of all the exemplary embodiments, it is particularly advantageous when the retaining element consists of plastics material. An alternative material still with, where applicable, sufficient flexibility could also be spring steel, but the retaining element could also consist of other metallic materials or composite materials.

In particular where the nominal diameters of the hoses are small, the plug-in nipple can be provided with a second groove, wherein the distance between the ends at the mounting mouth is then preferably smaller than the diameter of the groove bottom of the second groove. A corresponding second groove is for example provided in the named DIN standard for nominal diameters DN 6 to DN 12. In the case of larger nominal diameters from DN 19, it is particularly advantageous when the distance between the ends at the mounting mouth is smaller than the outside diameter of an associated shaft portion at the plug-in nipple in order to bring about the self-holding function at the shaft portion of the plug-in nipple, in particular when no holding lugs are provided.

### BRIEF DESCRIPTION OF THE DRAWINGS

Further advantages and developments are produced from the following description of exemplary embodiments shown in the drawing, in which:

FIG. 1 shows an exploded representation in perspective of a plug-in connection according to a first exemplary embodiment;

FIG. 2 shows a longitudinal section through the plug-in connection from FIG. 1 in the mounted state;

FIG. 3 shows a sectional view along III-III in FIG. 2;

FIG. 4 shows a perspective view of a retaining element according to a second exemplary embodiment;

FIG. 5 shows a plug-in connection in the mounted state according to a second exemplary embodiment;

FIG. 6 shows a sectional view along VI-VI in FIG. 5;

FIG. 7 shows a retaining element according to a third exemplary embodiment;

FIG. 8 shows a retaining element according to a fourth exemplary embodiment;

FIG. 9 shows a retaining element according to a fifth exemplary embodiment;

FIG. 10 shows the mounting procedure in the case of a plug-in connection with the retaining element according to FIG. 9; and

FIG. 11 shows the plug-in connection from FIG. 10 in the retained locked state.

### DETAILED DESCRIPTION

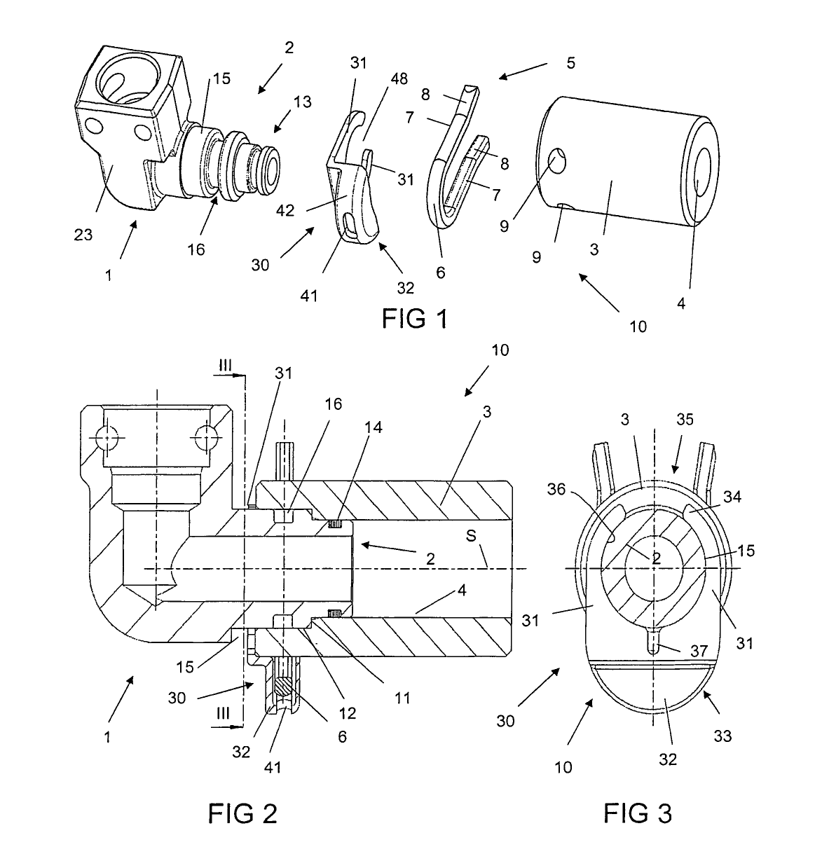

In FIGS. 1 to 3 the overall reference 10 is given to a plug-in connection according to a first exemplary embodiment for hydraulic hose lines, in particular for mining. Said plug-in connection may have a first plug connector part 1, which is provided with a plug-in nipple 2 and is frequently referred to as the male part, and may include a second plug connector part as a plug-in sleeve 3, which is realized with an inner bore 4 which, in this case, is stepped and into which the plug-in nipple 2 of the plug connector part 1 can be inserted parallel to the plug-in axis S so as to be hydraulically sealing. The plug-in sleeve 3 is frequently referred to also as the female part in the case of a plug-in connection.

For locking the plug-in nipple 1 and the plug-in sleeve 3 in the mounted state, there is provided a coupling bracket 5, which, in one piece, has a bracket curve 6 and two bracket portions 7 which are spaced apart from each other, the portion ends 8 of which are curved slightly outward, and which is preferably made of metal.

The first plug connector part 1 and the plug-in sleeve 3 are also preferably produced from metal, in particular brass. The plug-in sleeve 3, in this case, forms an arbitrary connection part for a hose or it forms a connection element that is situated directly on a hydraulic unit. As can easily be seen in FIG. 1, the plug-in sleeve 3 has two transverse bores 9, which cross the inner bore 4 in the bore portion 12, which is extended by means of the step 11, and which are positioned in such a manner that, in the mounted state of the plug-in sleeve 3 and the plug-in nipple 2, the transverse bores 9 intersect the region 12 extended by means of the step 11 inside the inner bore 4.

At the front plug-in nipple portion of the plug-in nipple 2 there is a circular groove 13 for accommodating an O-ring seal 14, which provides for the fluid-tight seat of the plug-in nipple 2 in the inner bore 4 of the plug-in sleeve 3. The shaft 15 of the plug-in nipple is additionally provided with a circumferential groove 16 which, in the mounted state of the plug-in nipple 2, lies opposite the transverse bores 8 in a flush manner, so that the coupling bracket 6 with its bracket portions 7 is able to engage in the groove 16 and can prevent the release of the plug-in nipple 2 and the plug-in sleeve 3 and consequently of the plug-in connection 10.

In FIGS. 1 to 3, the plug connector part 1 with the plug-in nipple 2 is realized as a right angle plug which is also provided at the same time with a second plug-in sleeve 23, to which a hose can be connected by means of a further plug-in nipple (not shown). A plug-in connection 10 designed in the afore-described manner is known from the prior art.

In this case, the present disclosure relates first to the retaining element 30 for retaining the coupling bracket 5 in the locked state when the plug-in connection 10 is mounted. The retaining element 30 may serve for the purpose of preventing the coupling bracket 5 being able to be released from its locked position during the ongoing operation. It is true that the widened ends 8 on the bracket portions 7 of the coupling bracket 5 may serve for the purpose of preventing such an unwanted release caused by creeping out, however, through incorrect mounting, the coupling bracket 5 can be deformed in such a manner that the widened portion ends 8 on the bracket portions 7 are no longer able to ensure this function.

The retaining element 30 can be mounted once the plug-in connection 10 has been produced in the usual manner. The retaining element 30 has two holding arms 31 which are spaced apart from each other as well as an accommodating portion 32, in which, in the mounted state such as shown for example in FIG. 2, the bracket curve 6 of the coupling bracket 5 is accommodated. The inner'ends of the holding arms 31 which are located facing the accommodating portion 32, as can easily be seen in particular in FIG. 3, are connected together in an integral manner by means of a base given the overall reference 33. The front ends 34 of the two holding arms 31 are spaced apart from each other and as a result define a mounting mouth which is indicated in FIG. 3 by way of the reference 35.

The mounting mouth 35, in the case of the exemplary embodiment according to FIGS. 1 to 3, can be slipped on over the shaft portion 15 of the plug-in nipple 2 in such a manner that the plug-in nipple 2 is able to penetrate the plug-in nipple gripping means 48 in the retaining element 30. A sufficient flexibility of the two holding arms 31 is necessary for the slipping on process and is achieved in this case, on the one hand, by the material selection of a suitable plastics material for the retaining element 30 and, on the other hand, by means of a slot 37, which is realized in part in the base 33 between the rear inner ends of the holding arms 31. The inner surfaces 36 of the holding arms 31, which are located facing each other, extend curved in a crescent-shaped manner as far as up to the front ends 34, as a result of which the holding arms 31, defining the plug-in nipple gripping means 48, can bear against the shaft 15 of the plug-in nipple 2 with a self-holding function in the mounted state. On account of the mounting mouth 35 which is open between the front ends 34, disassembly is also possible by pulling the retaining element 30 off the plug-in connection.

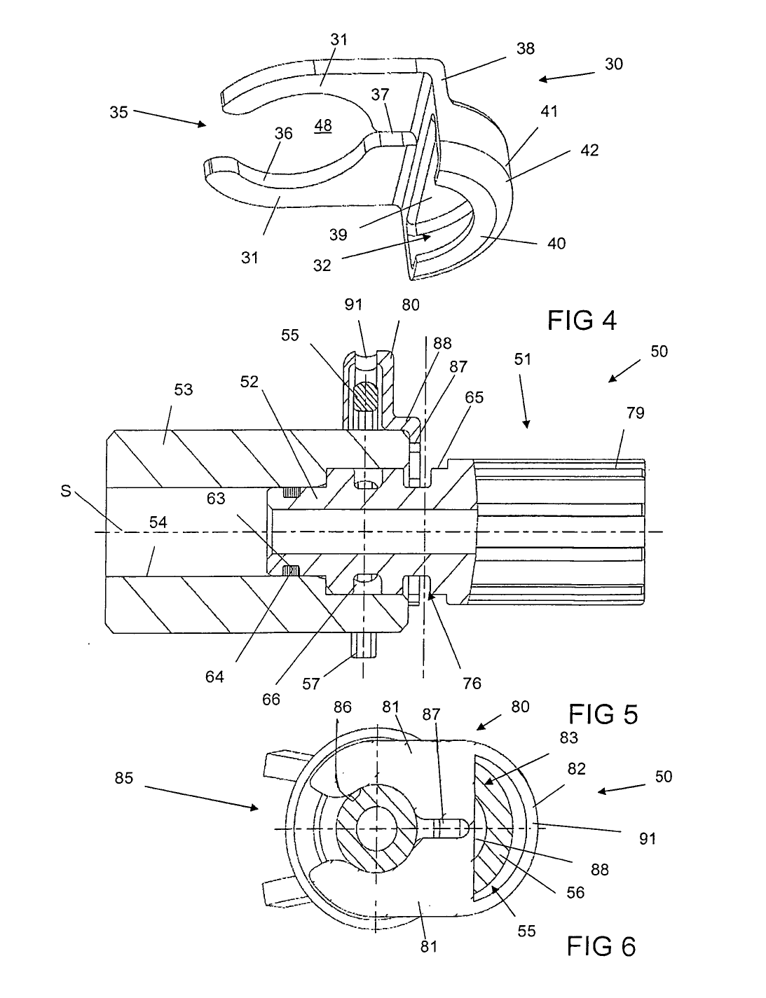

FIG. 4 shows the retaining element from FIGS. 1 to 3 in perspective and on its own. It can be clearly seen that the accommodating region 32 for the bracket curve of the coupling bracket is arranged axially offset with respect to the holding arms 31 with the mounting mouth 35 and the plug-in nipple gripping means 48. The holding arms 31 with the mounting mouth 35 consequently encompass the shaft portion on the plug-in nipple axially offset with respect to the position of the coupling bracket, as can be seen particularly well from FIG. 2. Strictly speaking, the holding arms 31 with the holding mouth 35 embrace the plug-in nipple 2 outside the plug-in sleeve 3, the axial offset preferably being selected in such a manner that, in the mounted state, the holding arms 31 abut against the top surface of the plug-in sleeve 3.

For the axial offset between the holding arms 31 and the accommodating portion 32, the base 33 forms a transition step by means of a step portion 38 which extends perpendicularly with respect to the holding arms 31. In this connection, the holding arms 31 extend on the one side and the accommodating portion 32 on the other side of the transition step 38. The accommodating portion 32, in turn, is realized as a circular arc segment with a rear wall 42, a top surface 39 and a bottom surface 40, the top surface 39 merging into the transition step 38 and extending, in turn, perpendicularly with respect to the transition step 38, consequently parallel to the holding arms 31, however offset axially hereto. The bottom surface 40 only forms an edge collar, which engages only in part under the bracket curve of the coupling bracket. By means of the development selected, the accommodating portion 32 at the same time forms a gripping portion for the retaining element 30, which consequently can easily be gripped at the accommodating portion 32 for mounting and easily slipped onto the mounted plug-in connection, in particular the coupling bracket. In order to ensure a visual check on the presence of the coupling bracket, the rear wall 42 is provided with an inspection opening 41.

FIGS. 5 and 6 show a second exemplary embodiment for a plug-in connection 50. A hydraulic hose line can be fastened, conducted in a straight manner, to the first plug-in part 51 forming the male part, for example by means of a hose coupling 79. The plug-in nipple 52 of the plug connector part 51 for the plug-in connection 50 has, along with an annular groove 63 for the O-ring seal 64, a first groove 66 into which the coupling bracket 55 with its bracket portions 57 engages in the mounted state, as shown in FIG. 5, and over and above this a second annular groove 76 on the shaft 65 between the first groove 66 and the fastening portion for the hose. The plug-in nipple 52 shown in FIG. 5 is preferably realized for nominal widths of hoses less than DN 20. Once the first plug connector part 51 has been completely mounted inside the inner bore 54 of the sleeve 53, for which purpose the plug-in nipple 52 is inserted into the inner bore 54 of the plug-in sleeve 53 parallel to the plug-in axis S, a retaining element 80, which can easily be seen in top view in FIG. 6, is mounted.

The retaining element 80 may be designed in the same fundamental manner as in the case of the previous exemplary embodiment and may comprise a base portion 83, an accommodating portion 82 as well as two holding arms 81 with rounded inner surfaces 86, however the spacing between said arms is dimensioned, in this case, in such a manner that the mounting mouth 85 with the bracket portions 81 is slipped over the bottom of the second groove 76 and can be held there with a self-retaining function as a result of the curvature of the holding portion 81.

In order to promote the widening of the holding arms 81, a slot 87 may also be realized here between the two holding arms 81 and extends as far as up to the base 83 and only ends quasi briefly in front of the transition portion 88. By means of the inspection opening 91 it is possible to check whether the bracket curve 56 and consequently the coupling bracket 55 are mounted. The front ends of the holding arms 81 transfer by means of roundings from the inner surfaces 86 to the outer surfaces in order to make it easier to slip the retaining element 80 onto the groove 76 in the shaft 65.

It can easily be seen from FIG. 5 that the groove is positioned in such a manner that it is located substantially abutting against the top surface of the plug-in sleeve 53 and the mounted retaining element 80 is located close to the top surface of the plug-in sleeve 53.

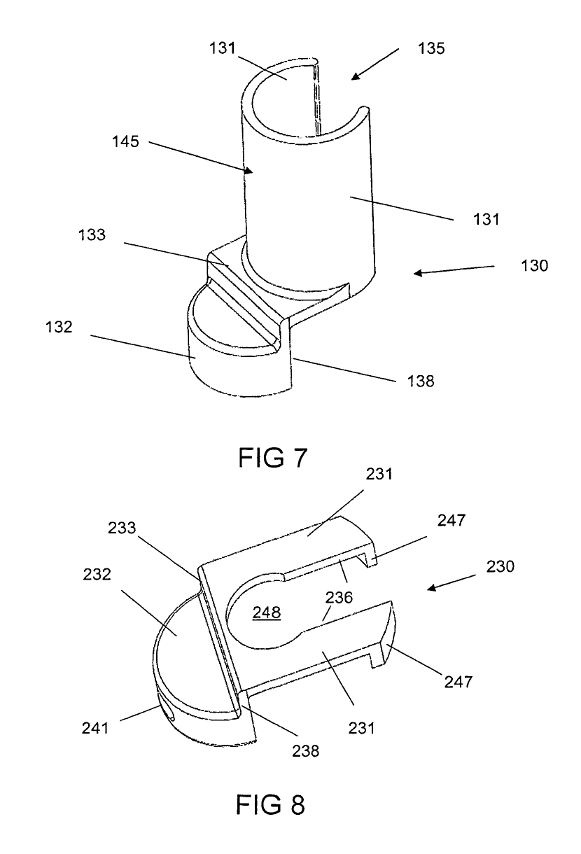

FIG. 7 shows a third exemplary embodiment of a retaining element 130, which is preferably used with such plug-in connections where a hose is conducted in a straight manner from the male part of the plug-in connection. The plug connector parts of the plug-in connection are not shown in FIG. 7. The retaining element 130 also has an accommodating portion 132 to cover over the bracket curve of the coupling bracket in the mounted state. The accommodating portion 132 is located by means of a transition step 138 in the base offset with respect to a cylindrical part shell 145 with a mounting mouth 135 on the side of the retaining element 130 located facing away from the accommodating portion 132. By way of its shell wings, the cylindrical part shell 145 forms in each case holding arms 131 which can embrace a hose or a coupling for a hose in the mounted state. Sufficient flexibility of the two holding arms 131 in relation to the base 133 of the retaining element 130 is necessary for the removal and mounting of the retaining element 130 and this can be achieved by selecting a suitable plastics material or by the wall thickness of the cylindrical part shell and the width of the mounting mouth. The height of the cylindrical part shell 145 also determines the clamping or retaining force.

FIG. 8 shows a fourth exemplary embodiment of a retaining element 230 for mounting on a substantially block-shaped plug-in sleeve. In this case too, two holding arms 231 are located axially offset with respect to an accommodating portion 232 with an inspection opening 241 for the bracket curve of a coupling bracket. The two holding arms 231 are connected to the base 233 and the circular gripping means 248 for the plug-in nipple of the male part is located directly bearing against the base 233. The plug-in nipple gripping means is defined by the holding arms 231 or the base 233 only over approximately 200° to 245° and the two holding arms 231 extend parallel to each other on the inner surfaces 236, outside of the plug-in nipple gripping means 248. Holding lugs 247, which extend in an angled manner downward and substantially parallel to the step 238, are realized on the front ends of the two holding arms 231 and in this case extend in a curved manner like the ends of the retaining arms 231 in order to be placed against a curved wall of a plug-in sleeve.

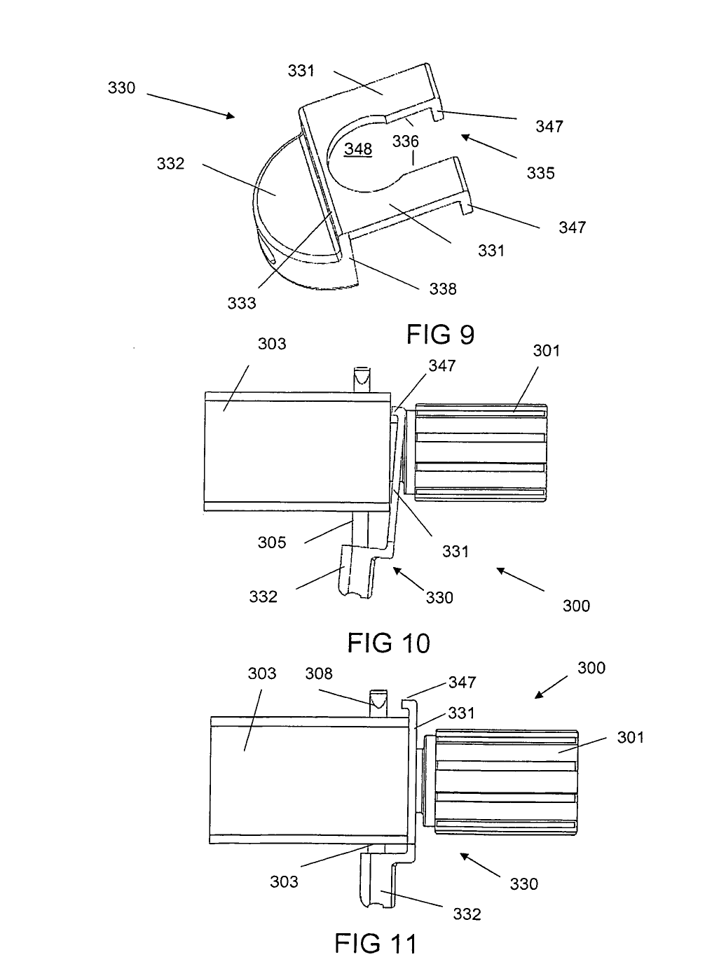

FIG. 9 shows a further exemplary embodiment of a retaining element 330 and FIGS. 10 and 11 show the mounting operation of the retaining element 330 on a plug-in connection 300. As in the case of the exemplary embodiment according to FIG. 8, the retaining element 330 has an accommodating portion 332 for the bracket curve of the coupling bracket 305, and the accommodating portion 332 is located by means of a transition step 338 axially offset with respect to two holding arms 331, which, close to the base 333, define a plug-in nipple gripping means 348 with a circular wall over a circumferential region of approximately 205°. Between the plug-in nipple gripping means 348 and the open mounting mouth 335, the inner surfaces 336 of the holding arms 331 extend as straight lines which are parallel to each other and are spaced apart at a constant distance.

The front ends of the two holding arms 331 may be angled downward and as a result may form holding lugs 347 for engaging behind a rear wall of the plug-in sleeve 303. This can be seen particularly well from FIGS. 10 and 11, in particular FIG. 11.

In FIG. 10 the retaining element 330 has not yet been completely slipped on and it is placed in position in such a manner that the hooks 347 can be slipped through between the first plug connector part 301 or the male part and the top surface of the plug-in sleeve 303, for which purpose the two holding arms 331 have to be expanded slightly through the flexibility of the material of the retaining element 330. During the slipping-through operation, the holding arms 331 are inclined and the bracket curve of the coupling bracket 305 engages progressively deeper into the inner recess of the accommodating portion 332 of the retaining element 330. As soon as the retaining element 330 has been slipped on far enough, the hook-shaped lugs 347 are freed from the top surface of the plug-in sleeve 303 and can spring back toward the free ends 308 of the bracket portion of the coupling bracket 305 such that the holding arms 331 can abut against the top surface of the plug-in sleeve 303, whilst the bracket curve is situated completely inside the accommodating portion 332 of the retaining element 330. In said position, the holding arms 331 are no longer expanded as the plug-in nipple gripping means 348 provides enough free space for the shaft of the plug-in nipple on the male part or on the first plug connector part 331 to penetrate the plug-in nipple gripping means 348 in a contactless manner or as a clearance fit. A self-holding function is achieved, on the one hand, by the smaller spacing between the inner surfaces of the holding arms 331 in comparison with the diameter of the plug-in nipple shaft in the region of the plug-in nipple gripping means 348 and, on the other hand, also by the hook-shaped lugs 347. It is obvious that in the case of the exemplary embodiment according to FIG. 9, either the hook-shaped lugs or the narrowing to the one side of the plug-in nipple gripping means could be omitted by the inner surfaces of the holding arms forming a semi-circular arc over 180° or less on the side of the base and from said point of curvature extending forward in a straight line, because just one of the two measures could suffice to prevent unwanted release of the coupling bracket by means of the self-holding function of the retaining element either on the shaft or on the plug-in sleeve. The retaining elements shown in FIGS. 8 and 9 with double the self-holding function both on the plug-in nipple and on the plug-in sleeve provide a particularly high level of safety against release.

### INDUSTRIAL APPLICABILITY

For the expert, the preceding description gives rise to numerous modifications which are to fall within the area of protection of the accompanying claims. The dimensions and relative proportions of the holding arms, the plug-in nipple gripping means and the accommodating element vary depending on the choice of coupling bracket, the choice of the nominal diameter of the line and of the material used for the retaining element. The development, for example of the hooked-shaped lugs, can vary, in particular when retaining elements are provided for quite specific plug-in connections. Where plastics materials are used, the selection of the correct retaining element for a specific plug-in connection can be simplified, for example, by means of the colour. Such and further modifications are to fall within the area of protection of the accompanying claims.

1-18. (canceled)

19. A plug-in connection, in particular for hydraulic hose lines, comprising:
a plug-in axis;
a first plug connector part having a plug-in nipple, a circumferential groove being provided on the plug-in nipple;
a plug-in sleeve as a female part, the plug-in sleeve being fittable together with the plug-in nipple and having two transverse bores;
a fork-shaped coupling bracket including two bracket portions and one bracket curve, the fork-shaped coupling bracket being inserted, in the mounted state of the plug-in sleeve and the plug-in nipple, into the transverse bores for locking the plug-in connection to the bracket portions and penetrating the groove transversely with respect to the plug-in axis; and
a retaining element for retaining the coupling bracket against unwanted release, wherein the retaining element includes;
an accommodating portion for the bracket curve; and
two holding arms, the two holding arms being spaced apart from each other, being connected by a base at rear ends of the holding arms facing the accommodating portion, and defining at front ends a mounting mouth which can be slipped onto the plug-in nipple and the plug-in sleeve in a transverse manner with respect to the plug-in axis of the plug-in connection.

20. The plug-in connection according to claim 19, wherein the mounting mouth forms a plug-in nipple gripping area with a self-holding function on the plug-in nipple.

21. The plug-in connection according to claim 20, wherein the holding arms have inner surfaces which are located facing each other, and the distance between front ends of the inner surfaces is smaller than at the plug-in nipple gripping area between the mounting mouth and the base.

22. The plug-in connection according to claim 21, wherein the inner surfaces extend in a curved manner in the shape of a crescent.

23. The plug-in connection according to claim 21, wherein the front ends having a rounded transition from their inner surfaces to their outer surfaces.

24. The plug-in connection according to claim 21, further comprising a slot provided in the base between the holding arms.

25. The plug-in connection according to claim 19, wherein the holding arms are coupled together by the accommodating portion.

26. The plug-in connection according to claim 25, wherein the accommodating portion comprises an inspection opening at the bracket curve.

27. The plug-in connection according to claim 19, wherein the holding arms with the mounting mouth are arranged axially offset with respect to the accommodating portion.

28. The plug-in connection according to claim 27, wherein the base forms a transition step between the accommodating portion and the holding arms for the axial offset, and wherein the holding arms extend on the one side and the accommodating portion extends on the other side of the transition step.

29. The plug-in connection according to claim 19, wherein the front ends of the holding arms comprise holding lugs which protrude perpendicularly downward toward the accommodating portion for gripping behind the plug-in sleeve.

30. The plug-in connection according to claim 19, wherein the accommodating portion comprises as a circular arc segment with a rear wall, a top surface and a bottom surface.

31. The plug-in connection according to claim 30, wherein the top surface merges into the transition step, which extends perpendicularly with respect to the top surface, and the bottom surface comprises as an edge collar which grips only in a partial manner under a bracket curve which is arranged in the accommodating portion.

32. The plug-in connection according to claim 19, wherein the holding arms form a cylindrical part shell which is slippable onto the circumference of the plug-in sleeve, onto the circumference of a hose end connected to the plug-in sleeve or onto a hose coupling at the end of the hose.

33. The plug-in connection according to claim 19, wherein the retaining element is produced from a plastics material.

34. The plug-in connection according to claim 19, wherein the plug-in nipple includes a second groove, and wherein the distance between ends at the mounting mouth is smaller than the diameter of a groove bottom of the second groove.

35. The plug-in connection according to claim 34, wherein the distance between the ends at the mounting mouth is smaller than the outside diameter of an associated shaft portion at the plug-in nipple.

36. A retaining element for retaining a coupling bracket having a bracket curve and bracket portions against unwanted release on a plug-in connection having a plug-in nipple and plug-in sleeve which can be fitted together on the plug-in connection, the retaining element comprising:
an accommodating portion for the bracket curve of the coupling bracket; and
two holding arms,
the two holding arms being spaced apart from each other,
the two holding arms being connected by a base at rear ends located facing the accommodating portion, and
the two holding arms defining at front ends a mounting mouth being slippable onto the plug-in nipple or a plug-in sleeve of the plug-in connection in a transverse manner with respect to a plug-in axis of the plug-in connection.
